(19) United States
(12) Patent Application Publication
(10) Pub. No.: US 2017/0016219 A1
(43) Pub. Date: Jan. 19, 2017

(54) Sink Drain Stopper Assembly

(71) Applicant: Jerry Kuo-Yung Kuo, Taichung City (TW)

(72) Inventor: Jerry Kuo-Yung Kuo, Taichung City (TW)

(21) Appl. No.: 14/990,839

(22) Filed: Jan. 8, 2016

(30) Foreign Application Priority Data
Jul. 16, 2015 (TW) 104211462

(51) Int. Cl. E03C 1/23; F16K 31/60; A47K 1/14

(52) U.S. Cl. CPC E03C 1/2302; A47K 1/14; F16K 31/602

(57) ABSTRACT

The sink drain stopper assembly includes a pipe member, an annular member, a sealing unit, a fixing nut, and a valve unit. The pipe member has a body portion, a first external thread formed on the body portion, a second external thread spaced apart from the first external thread along a central axis, and a side hole disposed under the second external thread. The body portion and the first and second external threads are molded as one piece. The annular member is coupled threadedly to the first external thread. The fixing nut is coupled threadedly to the second external thread. The valve unit includes a valve member and a pivot rod. Movement of the valve member along the central axis is driven by pivot movement of the pivot rod.

### CROSS-REFERENCE TO RELATED APPLICATION

This application claims priority of Taiwanese Application No. 104211462, filed on Jul. 16, 2015.

### FIELD

The disclosure relates to a drain stopper assembly, more particularly to a sink drain stopper assembly.

### BACKGROUND

As shown in FIG. 1, a conventional sink drain stopper assembly 1 is adapted to be installed in a sink (not shown), and includes an upper pipe member 11, a sealing unit 12, a fixing nut 13, a threaded member 14, a lower pipe member 15, and a valve unit 16. The sink includes a bottom wall that has opposite upper and lower surfaces. The upper pipe member 11 has an annular portion 111, an extending portion 112, and a plurality of angularly spaced-apart through holes 113 formed in the extending portion 112 and arranged circumferentially. The sealing unit 12 includes a washer 121 and a sealing member 122. The lower pipe member 15 has an inner thread 151 and a side hole 152. The valve unit 16 includes a valve member 161 and a pivot rod 162.

When installing the conventional sink drain stopper assembly 1, the upper pipe member 11 is first inserted into the bottom wall of the sink through the upper surface, and the threaded member 14 is then inserted into the bottom wall of the sink through the lower surface and is coupled threadedly to the upper pipe member 11. The sealing unit 12 is then sleeved on the threaded member 14, and the fixing nut 13 is coupled threadedly to the threaded member 14 for locking tightly the sealing unit 12 to the lower surface of the bottom wall of the sink. Finally, the lower pipe member 15 is coupled threadedly to the threaded member 14, the valve member 161 of the valve unit 16 is inserted into the upper pipe member 11, and the pivot rod 162 is placed with one end thereof being pivoted to the valve member 161 and an opposite end thereof extending outwardly of the lower pipe member 15 through the side hole 152.

Subsequently, the pivot rod 162 has to be pivoted to a control rod disposed on the sink (not shown) so that the pivot action of the pivot rod 162 can be easily driven by a user. However, during the abovementioned installation of the conventional sink drain stopper assembly 1, when the connection between the lower pipe member 15 and the threaded member 14 is completed, the opposite end of the pivot rod 162 that extends outwardly of the side hole 152 may not be able to be successfully pivoted to the control rod because due to a deviation in the orientation of the side hole 152. At this time, the user has to loosen the fixing nut 13 to readjust the orientation of the lower pipe member 15 until the side hole 152 is at a correct orientation. Such readjustment of the lower pipe member 15 often results in an inconvenient operation of the conventional sink drain stopper assembly 1.

### SUMMARY

Therefore, the object of the disclosure is to provide a sink drain stopper assembly that can be conveniently installed.

Accordingly, a sink drain stopper assembly of the present disclosure is adapted to be installed in a sink. The sink includes a bottom wall that has opposite upper and lower surfaces. The sink drain stopper assembly includes a pipe member, an annular member, a sealing unit, a fixing nut, and a valve unit. The pipe member has a body portion, a first external thread, a second external thread, and a side hole. The body portion surrounds a central axis and is adapted to extend into the bottom wall of the sink through the lower surface. The first external thread and the second external thread are formed on the body portion, and the second external thread is disposed under and spaced apart from the first external thread along the central axis. The side hole is formed in the body portion and is disposed under the second external thread. The body portion and the first and second external threads are molded as one piece. The annular member has an annular main body that is adapted to extend into the bottom wall of the sink through the upper surface, and that is formed with a central hole through which the central axis passes. The annular member further has an internal thread that is formed on the main body and that is coupled threadedly to the first external thread of the pipe member. The sealing unit includes a washer and a sealing member that are sleeved on the body portion of the pipe member. The fixing nut is coupled threadedly to the second external thread of the pipe member for locking tightly the annular member and the sealing unit to the bottom wall of the sink. The valve unit includes a valve member and a pivot rod. The valve member extends into the body portion of the pipe member and is movable relative to the annular member along the central axis to block or unblock the central hole. The pivot rod has one end pivoted to the valve member and an opposite end extending outwardly of the side hole of the pipe member, such that the movement of the valve member along the central axis is driven by pivot movement of the pivot rod relative to the valve member.

### BRIEF DESCRIPTION OF THE DRAWINGS

Other features and advantages of the disclosure will become apparent in the following detailed description of the embodiment with reference to the accompanying drawings, of which:

FIG. 1 is an exploded perspective view of a conventional sink drain stopper assembly;

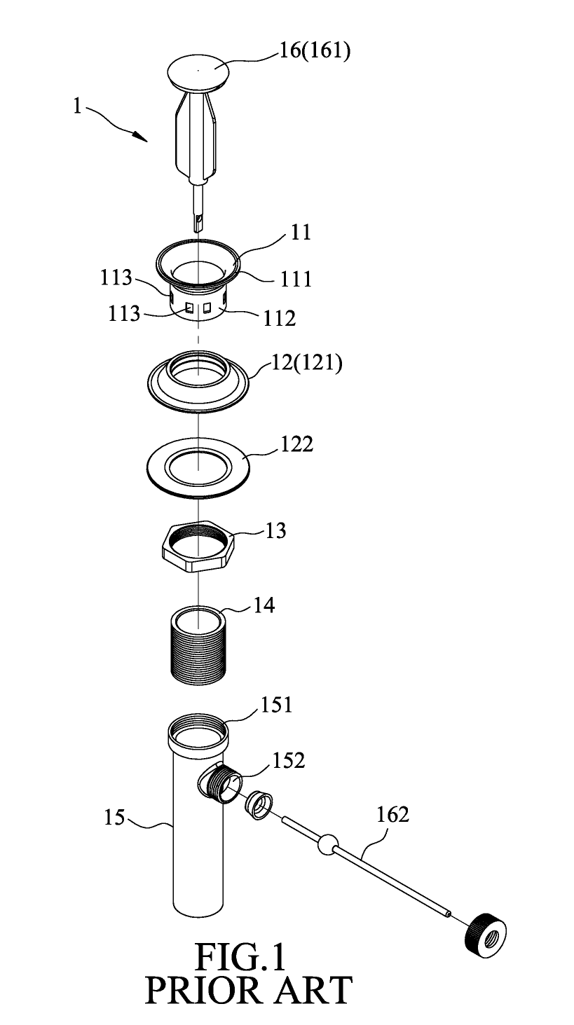

FIG. 2 is an assembled perspective view of an embodiment, of a sink drain stopper assembly according to the disclosure;

FIG. 3 is an exploded perspective view of the embodiment; and

FIG. 4 is a sectional view of the embodiment illustrating a pivot movement of a valve unit.

### DETAILED DESCRIPTION

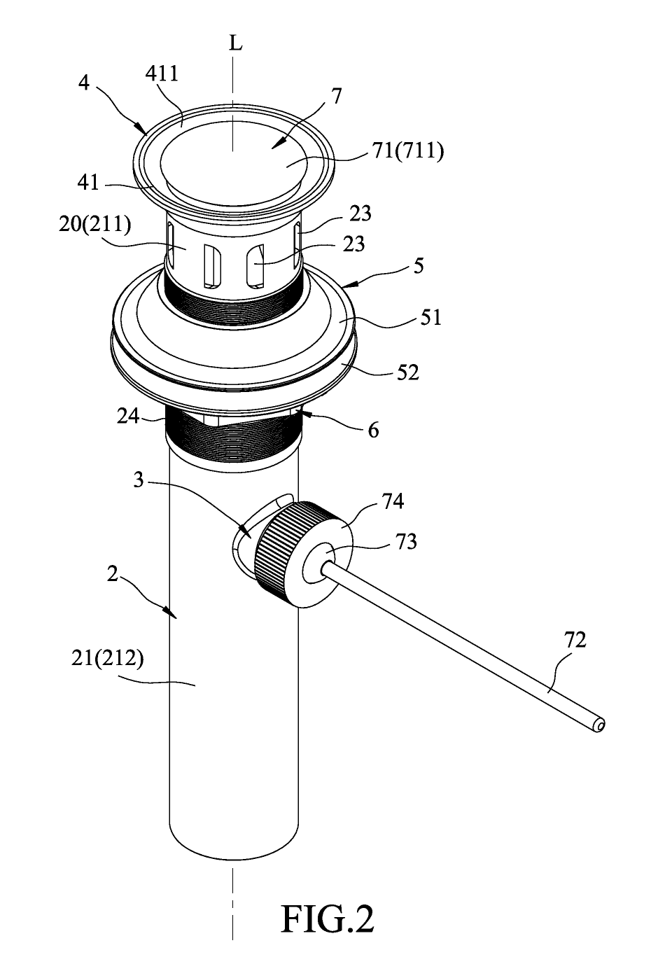

As shown in FIGS. 2, 3, and 4, the embodiment of a sink drain stopper assembly according to the present disclosure is adapted to be installed in a sink 9 that includes a bottom wall having opposite upper and lower surfaces 901, 902.

The sink drain stopper assembly includes a pipe member 2, an extending member 3, an annular member 4, a sealing unit 5, a fixing nut 6, and a valve unit 7.

The pipe member 2 is made of metal and has a body portion 21, a first external thread 22, a second external thread 24, a plurality of through holes 23, and a side hole 25.

The body portion 21 surrounds a central axis (L) and is adapted to extend into the bottom wall of the sink 9 through the lower surface 902. The body portion 21 has a wide section 211 and a narrow section 212 that has a diameter smaller than that of the wide section 211, and that extends downwardly from the wide section 211.

The first external thread 22 is formed on the body portion 21, the second external thread 24 is formed on the body portion 21 and is disposed under and spaced apart from the first external thread 22 along the central axis (L), and the side hole 25 is formed in the body portion 21 and is disposed under the second external thread 24. The body portion 21 and the first and second external thread 22, 24 are molded as one piece.

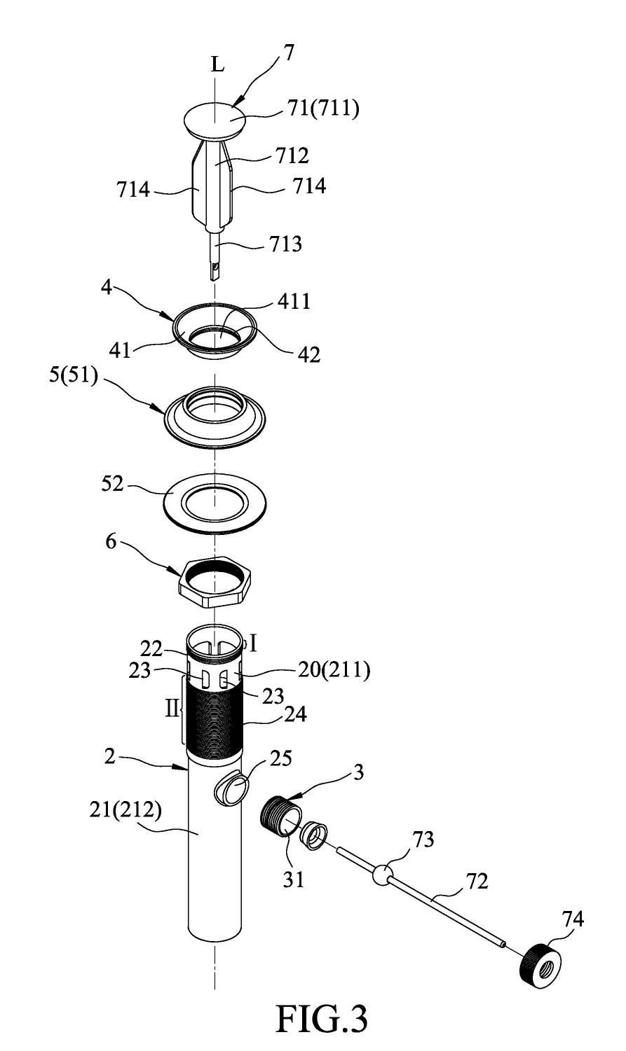

The through holes 23 are angularly spaced-apart from each other, are formed between the first and second external threads 22, 24, and surround the central axis (L). The side hole 25 is formed in the narrow section 212 of the body portion 21, and the first and second external thread 22, 24 and the through holes 23 are formed in the wide section 211 of the body portion 21. As shown in FIG. 3, a length (I) of the first external thread 22 along the central axis (L) is shorter than a length (II) of the second external thread 24 along the central axis (L). The second external thread 24 and the first external thread 22 are respectively proximate to and distal from the narrow section 212 of the body portion 21 along the central axis (L). It should be noted that a thread form of the first external thread 22 may be the same as or different from that of the second external thread 24 when required.

In this embodiment, the pipe member 2 is made of stainless steel, and may be made through punching press, turning, or other manufacturing methods.

The extending member 3 is mounted on the pipe member 2 and is formed with an inserting hole 31 communicating with the side hole 25. In this embodiment, the extending member 3 is welded onto the narrow section 212 of the pipe member 2.

The annular member 4 is made of metal, has an annular main body 41 that is adapted to extend into the bottom wall of the sink 9 through the upper surface 901, and is formed with a central hole 411 through which the central axis (L) passes. The annular member 4 further has an internal thread 42 that is formed on the main body 41 and that is coupled threadedly to the first external thread 22 of the pipe member 2.

The annular member 4 may be made through punching press or other manufacturing methods. In this embodiment, the annular member 4 is made of stainless steel.

The sealing unit 5 includes a washer 51 and a sealing member 52 sleeved on the body portion 21 of the pipe member 2. The washer 51 is of a substantially frusto-conical configuration and can abut against the lower surface 902 of the bottom wall of the sink 9. The sealing member 52 is made of an elastic material such as rubber. Structure and function of the sealing unit 5 are well known in the art, and is therefore not further described herein.

The fixing nut 6 is coupled threadedly to the second external thread 24 of the pipe member 2 for locking tightly and respectively the annular member 4 to the upper surface 901 of the bottom wall of the sink 9 and the sealing unit 5 to the lower surface 902 of the bottom wall of the sink 9. The fixing nut 6 is in a polygon shape in order to be fitted with a spanner. In this embodiment, the fixing nut 6 is in a hexagonal shape.

The valve unit 7 includes a valve member 71, a pivot rod 12, a sealing ball 73, and a lock cap 74. The valve member 71 extends into the body portion 21 of the pipe member 2, is movable relative to the annular member 4 along the central axis (L), and has a stopper 711 and a rod portion 712 extending downwardly from the stopper 711. The stopper 711 has a shape corresponding to the central hole 411 of the annular member 4 so that the stopper 711 can block or unblock the central hole 411 when the valve member 71 is moved along the central axis (L) downwardly to or upwardly away from the annular member 4, respectively. An O-ring may be disposed on the stopper 411 to increase sealing efficiency when the central hole 411 is blocked by the stopper 711. The rod portion 712 has a rod body 713 extending downwardly from the stopper 711 and three angularly spaced-apart fin plates 714 projecting from the rod body 713.

The pivot rod 72 has one end pivoted to the rod body 713 of the valve member 71, and an opposite end extending outwardly of the side hole 25 of the pipe member 2. The sealing ball 73 is received in the inserting hole 31 of the extending member 3, and the lock cap 74 is coupled removably to the extending member 3 so as to retain the sealing ball 73 in the inserting hole 31. The pivot rod 72 extends through the lock cap 74 and the sealing ball 73. As such, the movement of the valve member 71 along the central axis (L) is driven by pivot movement of the pivot rod 72 relative to the valve member 71. The sealing ball 73 can prevent water leakage through the inserting hole 31 and hold firm the pivot rod 72, and is made of an elastic material such as rubber.

When installing the sink drain stopper assembly according to the disclosure, the fixing nut 6 is first locked, to the second external thread 24 of the pipe member 2, and the sealing unit 5 is then sleeved on the pipe member 2. The annular member 4 then extends into the bottom wall of the sink 9 through the upper surface 901, and the pipe member 2 extends into the bottom wall of the sink 9 through the lower surface 902. The pipe member 2 is then rotated to threadedly couple the first external thread 22 to the inner thread 42 of the annular member 4, such that the orientation of the side hole 25 is adjusted simultaneously. Finally, the fixing nut 6 is screwed to lock tightly the sealing unit 5 to the lower surface 902 of the bottom wall of the sink 9, and the valve member 71 of the valve unit 7 is inserted into the annular member 4 and pivoted to the rod body 713 of the valve member 71.

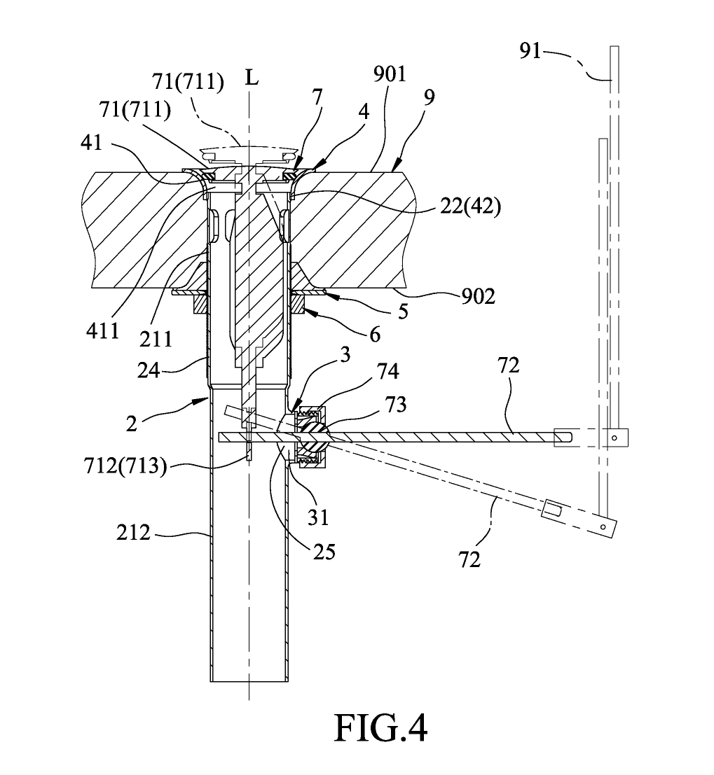

Referring to FIG. 4, the opposite end of the pivot rod 72 is adapted to be pivoted to a control rod 91, so that a user can push the control rod 91 to actuate the pivot movement of the pivot rod 72 about the sealing ball 73 relative to the valve member 71. When the stopper 711 blocks the central hole 411, water in the sink 9 can be held, and when the stopper 711 unblocks the central hole 411, the water flows out of the sink 9 through the central hole 411.

It should be noted that the through holes 23 of the pipe member 2 are formed in a through hole section 20 of the body portion 21 located between the first external thread 22 and the second external thread 24. An outer diameter of the through hole section 20 is configured to be slightly smaller than an outer diameter of the first external thread 22 and an outer diameter of the second external thread 24, so that the fixing nut 6 can pass smoothly through the first external diameter 22 to the second external thread 24 without interference from the through hole section 20.

The following advantages can be concluded from the above-mentioned description:

1. During the threaded coupling of the pipe member 2 to the annular member 4, the orientation positioning of the side hole 25 can be simultaneously adjusted to a required position before the fixing nut 6 is screwed. In such manner, the pivot rod 72 can be pivoted to the control rod 91 without requiring the additional adjustments disclosed in the abovementioned prior art. As a result, the installation process is more convenient.

2. The length of the first external thread 22 along the central axis (L) is short, so that the annular member 4 can be quickly coupled to the pipe member 2.

3. The annular member 4 and the pipe member 2 are made of stainless steel so that a need for surface machining is not required, thereby decreasing the manufacturing cost.

4. The body portion 21 and the first and second external threads 22, 24 are molded as one piece instead of being formed individually and coupled together. Therefore, the sink drain stopper assembly of the disclosure has a simpler installation process. Moreover, water leakage from the pipe member 2 can be avoided.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A sink drain stopper assembly adapted to be installed in a sink, the sink including a bottom wall that has opposite upper and lower surfaces, said sink drain stopper assembly comprising:
a pipe member having a body portion that surrounds a central axis and that is adapted to extend into the bottom wall of the sink through the lower surface, a first external thread that is formed on said body portion, a second external thread that is formed on said body portion and that is disposed under and spaced apart from said first external thread along the central axis, and a side hole that is formed in said body portion and that is disposed under said second external thread, said body portion and said first and second external threads being molded as one piece;
an annular member having an annular main body that is adapted to extend into the bottom wall of the sink through the upper surface, and that is formed with a central hole through which the central axis passes, said annular member further having an internal thread that is formed on said main body and that is coupled threadedly to said first external thread of said pipe member;
a sealing unit including a washer and a sealing member that are sleeved on said body portion of said pipe member;
a fixing nut coupled threadedly to said second external thread of said pipe member for locking tightly said annular member and said sealing unit to the bottom wall of the sink; and
a valve unit including a valve member that extends into said body portion of said pipe member and that is movable relative to said annular member along the central axis to block or unblock said central hole, and a pivot rod that has one end pivoted to said valve member and an opposite end extending outwardly of said side hole of said pipe member, such that movement of said valve member along the central axis is driven by pivot movement of said pivot rod relative to said valve member.

2. The sink drain stopper assembly as claimed in claim 1, wherein said pipe member and said annular member are made of stainless steel.

3. The sink drain stopper assembly as claimed in claim 1, wherein a length of said first external thread along the central axis is shorter than that of said second external thread along the central axis.

4. The sink drain stopper assembly as claimed in claim 1, wherein said body portion has a wide section, and a narrow section that has a diameter smaller than that of said wide section, and that extends downwardly from said wide section.

5. The sink drain stopper assembly as claimed in claim 1, wherein said pipe member further has a plurality of angularly spaced-apart through holes formed between said first and second external threads and surrounding the central axis.

6. The sink drain stopper assembly as claimed in claim 1, further comprising an extending member that is mounted on said pipe member and that is formed with an inserting hole communicating with said side hole, said valve unit further including a sealing ball that is received in said inserting hole and a lock cap that is coupled removably to said extending member so as to retain said sealing ball in said inserting hole, said pivot rod extending through said lock cap and said sealing ball.

7. The sink drain stopper assembly as claimed in claim 6, wherein said extending member is welded onto said pipe member.
